(19) United States
(12) Patent Application Publication
(10) Pub. No.: US 2003/0080056 A1
(43) Pub. Date: May 1, 2003

(54) Extraction of biological components from body fluids

(76) Inventors: Karl-Siegfried Boos, Gauting (DE); Seidel Dietrich, Feldafing (DE)

Correspondence Address: Arent Fox Kintner, Plotkin & Kahn, Suite 600, 1050 Connecticut Avenue NW, Washington, DC, 20036-5339, US

(21) Appl. No.: 10/168,533

(22) PCT Filed: Dec. 27, 2000
(86) PCT No.: PCT/EP00/13294

(30) Foreign Application Priority Data
Dec. 28, 1999 (DE) 19963420.3

(51) Int. Cl. B01D 11/00

(52) U.S. Cl. 210/634; 210/702; 210/767; 604/4.01; 436/8; 436/13

(57) ABSTRACT

The invention relates to a process for the obtainment of biological components from body fluids, in particular from blood, blood plasma or serum. The biological components are obtained in native and biologically active form and can be employed, for example, for therapeutic purposes and for the preparation of control samples or standards for diagnostic tests.

### DESCRIPTION

The invention relates to a process for the obtainment of biological components from body fluids, in particular from blood, blood plasma or serum. The components are obtained in native form or a form which is active biologically to the greatest possible extent and can be employed, for example, for the preparation of control samples or standards for diagnostic tests or for the preparation of highly concentrated infusion/nutrient or/and incubation solutions for therapeutic or/and biological purposes.

Quality assurance in the medical laboratory should primarily serve for the welfare of the patients. The highest possible quality standard should be guaranteed to them in laboratory investigations in order to avoid misclassifications and diagnostic and therapy errors resulting therefrom. Moreover, quality assurance of the laboratory results serves for the protection of the laboratory personnel and the physician responsible in the case of, for example, contentious questions on account of wrong analytical results or classifications. Quality assurance for medical laboratories is laid down by the guidelines of the federal physician's association for the federal republic of Germany (RILI-BÄK) and comparably by corresponding regulations in most other countries. Correspondingly, the RILI-BÄK is part of the weights and measures organization and thereby has legal character.

Quality control in the medical laboratory should fulfill the following tasks:

1. The monitoring of random measuring differences (precision control)

2. The monitoring of systematic measuring differences (accuracy control)

3. The control of matrix influences on accuracy, precision and specificity of the measurement.

4. The recognition of trends (e.g. stability of the measuring systems).

Quality assurance according to these guidelines comprises quality control in the laboratory (precision and accuracy control) and external accuracy control in the form of cooperative experiments. It must—if technically possible—be carried out for all clinico-chemical parameters investigated.

Random quality control in the laboratory is carried out using a control samples system which has to fulfill two different requirements:

1. Precision control

2. Accuracy control

For the control of the precision, it is adequate if it is carried out at the most frequent decision limit. Control of the accuracy must be carried out over the range of the measured variable which is clinically relevant in each case. It should therefore also be possible outside the normal range, in the pathological range.

Accuracy is understood as meaning the agreement of the analytical results with the “true value”. Accordingly, there is only a single reference method value for a measured variable in a sample, but many methodical theoretical values. An indispensable prerequisite for the determination of a true value of the analyte in a control serum is therefore the fact that the analyte in the control material as accurately as possible reflects the form, structure and nature of the substance in which it is also present in native form in the patient sample.

In the precision control, the same control material should be employed over as long a period of time as possible. This condition requires a high stability of the measured variable in the control material used. For each analyte series, at least one precision control sample must be analyzed. If the result of the control sample does not lie within the control limits required, the cause must be determined and the entire analyte series repeated. The control of the accuracy has a particularly great influence on the percentage of misclassifications of patient samples and is thus of greatest clinical relevance.

The cooperative experiments set the legally prescribed external accuracy control and assist the internal accuracy control of the medical laboratory. The assessment of the cooperative test results is accordingly carried out according to the same criteria as in the accuracy control in the laboratory.

In principle, it is true that both the internal precision and accuracy control and the external accuracy control should be carried out using a control material which to the greatest possible extent matches all conditions and methodically relevant specifications of the investigation material of the patients.

This requirement, however, cannot be fulfilled or can only be fulfilled to a restricted extent hitherto, i.e. unsatisfactorily, for certain analytes. This applies in particular for high molecular weight compounds or/and complexes, for whose synthesis various cell activities and metabolic processes in certain organs or in an entire body are a prerequisite.

The invention is therefore based on the object of making available a process for the obtainment of components of this type in unchanged native form, which is suitable for the preparation of sample or control materials in liquid or solid, e.g. lyophilized, form preferentially based on plasma or serum. In this case, the sample and control materials obtained should fulfill the criteria for the clinicochemical quality control (inter alia accuracy, precision, specificity and stability). In particular, the invention should achieve the object of preparing sample or control materials whose components are present in the upper normal or pathologically elevated range. The invention should also achieve the object of preparing infusion, nutrient or/and incubation solutions or fractions suitable therefor, whose biological component(s) are present in native or active form and in high concentration.

According to the invention, the object mentioned was achieved in that, for the obtainment of the native components, use is preferably made of processes which are employed as a therapeutic measure in patients in order to eliminate substances of this type from body fluids, i.e. the blood and/or plasma or serum of the patients using an extracorporeal apheresis system. The separation and recovery of the components in native or active form according to invention, however, can also be carried out from freshly obtained (donated) or from appropriately preserved blood, plasma or serum.

Surprisingly, it has been found that substances of this type—after these have been obtained from body fluids, e.g. blood, serum or plasma of humans or animals, in an extracorporeal separation system by filtration, adsorption or/and precipitation—can be recovered again in biologically active form and can be made available as a concentrate in the native state. These concentrates can then in turn be treated with solutions such as, for example, physiological saline solution and/or matrices such as, for example, blood, plasma, serum, urine, cerebrospinal fluid and albumin solution in order, for example, to prepare sample or control materials whose components are present in the upper normal or pathologically elevated range.

The invention thus relates to a process for the obtainment of biological components, comprising the recovery of components in biologically native and active form, which have previously been separated from a body fluid, in particular blood or/and plasma. The and/or separation is preferably carried out by precipitation, and adsorption or filtration. The separation can be carried out, for example, in a suitable extracorporeal separation or apheresis system. A preferred example of an extracorporeal apheresis system of this type is the H.E.L.P. system, which is based on a largely specific precipitation of low density lipoproteins (LDL) and Lp(a) from the plasma of patients in need of treatment in the presence of heparin at a low pH (Klinische Wochenschrift 65, 161-168, 1987). Other extracorporeal elimination systems for lipoproteins are based on a size-dependent membrane filtration or an adsorption on modified, porous carrier materials such as, for example, dextran sulfate-cellulose and sepharose with immobilized antibodies against apolipoprotein B-100 (International Journal of Artificial Organs 12, 61-65, 1989) or a copolymer with polyacrylic acid ligands (EP 0 424 698 B1). The filtrates or adsorbates obtained in each case can likewise be used as a starting material.

Examples of biological components to be obtained in this way are proteins, lipids, in particular fractions, subfractions, isoforms or mixtures of plasma lipoproteins (see table 1), cytokines such as, for example, TNFα, peptides, growth factors, antibodies, enzymes, hormones, lipopolysaccharides, lipoteichoic acids and other high molecular weight plasma constituents.

The recovery of the biological components comprises their reconstitution in biologically native or active form. For this, a precipitate containing the desired components or an absorber loaded with the desired components or a filtrate is preferably brought into contact with a suitable buffer under conditions which lead to a reconstitution of the desired components in the buffer in biologically native form. In the case of the obtainment of lipoproteins, it has proven favorable to use a buffer which contains a lipid-free protein, for example delipidated albumin, which is free of free fatty acids. After obtainment, the biological components can be lyophilized and, if required, reconstituted in a suitable medium, e.g. in a body fluid or a buffer, with retention of their native form and/or biological activity.

The biological components obtained by the process can be put to any desired uses. Thus certain lipoprotein fractions, for example, preferentially HDL or Lp(a), can be used for therapeutic purposes (cf. example 2). For this, the isolated lipoprotein such as, for example, Lp(a) is infused into a patient in order to act protectively with respect to an infection or sepsis. The highly concentrated solutions according to the invention are very particularly suitable for infusion purposes, since on the one hand the amount of the appropriate components infused is very high and on the other hand the volume of the appropriate infusion solution infused can be kept relatively small. By means of this, the dose and/or therapeutic efficiency can be increased without undesired hemodynamic disturbances of the blood circulation of a patient occurring. Moreover, the process according to the invention allows a patient for the first time to concentrate therapeutically beneficial components before an appropriate therapy by means of one or more extracorporeal own-blood treatments and, for example, to prepare it in the form of an infusion solution. Highly concentrated solutions of this type are also suitable for the preparation of nutrient and incubation media for cell cultures (cf. example 3). However, the preparation of controls or standards for diagnostic tests, e.g. for the determination of cholesterol, of any type of lipoprotein, of the (apo)lipoproteins A, B, C, E, their isoforms, or for the determination of lipids of certain lipoprotein fractions is particularly preferred. Particularly preferably, controls or standards are prepared which contain a component to be detected, i.e. contain the diagnostic parameter in the upper normal range or in the pathologically elevated range (cf. example 4).

In addition, the present invention will be described by example of the obtainment of plasma lipoproteins, in particular of the LDL fraction with its subunits, and Lp(a) from an extracorporeal blood or plasma perfusion system. The system of heparin-induced extracorporeal elimination of plasma proteins (H.E.L.P. therapy) has proven particularly preferred here.

### EXAMPLES

### Example 1

### Obtainment of Plasma Lipoproteins

1.1 Nomenclature and composition of the plasma lipoproteins

The lipids of the blood plasma (cholesterol, triglycerides and phospholipids) are by their nature water-insoluble and are present in soluble form in the aqueous medium of the blood due to the combination with specific proteins. These particulate complexes are designated as plasma lipoproteins.

The plasma lipoprotein spectrum of man results from the absolute concentrations and the concentration ratios of various plasma lipoprotein fractions to one another. Differences between plasma lipoproteins can be expressed, for example, in their size. Closely related to the size is the specific weight of the lipoproteins. Differences in the specific weight are made use of for their separation with the aid of the ultracentrifuge. This separation and analysis system is the origin of a nomenclature of the lipoproteins which is still customary today (chylomicrons; VLDL d<1.006 g/ml; LDL d=1.006−1.063 g/ml; HDL d=1.063−1.250 g/ml).

TABLE 1
The plasma lipoproteins of man

| | VLDL | | LDL | HDL | |
|---|---|---|---|---|---|
| Density | d < 1.006 g/ml | | d = 1.006-1.063 g/ml | d = 1.063-1.21 g/ml | d > 1.25 |
| Electrical mobility | Chylomicrons | Pre-β-LP | β-LP | α-LP | Apolipo- |
| Protein | 1% | 8-10% | 20% | 48% | proteins + |
| Cholesterol | 6% | 13% | 45% | 20% | proteins |
| Triglycerides | 85-90% | 60% | 10% | 2-5% | |
| Phospholipids | 4% | 18% | 23% | 30% | |

| Main | | Lp(a) | |
|---|---|---|---|
| apolipoprotein | B, C, E | B(C, E) | A(C, E, B) |
| distribution | | | |
| A | | | |

An almost equally entitled nomenclature is based on different electrical charges and correspondingly different electrophoretic mobilities of the plasma proteins. β-, pre-βp- and α-lipoproteins are differentiated here. For chylomicrons, an ultra centrifuge is not needed in order to bring them to flotation; in the electrophoretic separation they remain at the start. Density classes and electrophoretic bands essentially correspond (see table 1).

1.2 Disturbances of the lipid metabolism

Of all metabolic disorders of man, in addition to diabetes mellitus, the hyperlipoproteinemias are the most frequent and of particular clinical relevance. They are regarded as the main risk factor for the development of cardiovascular disorders and are thus mainly responsible for the most frequent cause of death in the federal republic of Germany and in other industrial countries. The determination of the individual lipoprotein fractions in their concentration and quality is therefore clinically of outstanding importance. Concentration shifts of these fractions absolutely and relative to one another (hyper-lipoproteinemias, dyslipoproteinemias) cannot be detected safely by a sole determination of the blood lipids, the plasma cholesterol, the triglycerides and the phospholipids. Conversely, a soundly based risk estimation and a target-directed therapy are based on a precise analysis of the lipoproteins. Thus all recommendations for the treatment of lipid metabolic disturbances, in particular with respect to the prevention of cardiovascular disorders, necessitate an accurate determination of the concentration and a corresponding therapeutic target specification, particularly of the low-density lipoproteins (LDL) and high density lipoproteins (HDL) or their corresponding cholesterol components. Following this therapeutic intervention concept, the analytical determination methods must be orientated to determining the concentration of the lipoproteins in the plasma or serum precisely and correctly. This applies in particular for the upper normal or pathological range. At present, various analytical-diagnostic procedures for the routine quantification of the plasma lipoproteins are available. Nevertheless, hitherto no control materials containing native plasma lipoproteins in the upper normal and/or pathologically elevated range are available. Therefore this concentration range—crucial for therapeutic intervention and course control—escapes from an adequate accuracy control and thus the quality control in diagnosis and in the course of therapy.

The complex structure of the human plasma lipoproteins demands a high biological synthesis power at the cellular level and in the entire body, which can hitherto not be understood in vitro or with the aid of recombinant techniques. Also, high concentrations of lipoproteins cannot be achieved by the accumulation of individual lipids, e.g. cholesterol, triglycerides or phospholipids, since the lipids, as water-insoluble substances, lead to the turbidity of such control materials, which influences or makes impossible the determination of a large number of other analytes. Conversely, the use of plasma or serum of patients who suffer from hyper- or dyslipoproteinemia, is not available quantitatively in sufficient amount for it to be used for the preparation of quality control materials.

1.3 The H.E.L.P. treatment

The principle of the H.E.L.P. treatment is based on a specific precipitation of the low-density lipoproteins and of Lp(a) from the plasma of patients in need of treatment in the presence of heparin at low pH.

In a first step, the blood cells are separated from the plasma with the aid of a plasma separator. The blood cells are immediately fed back to the patient, the plasma is continuously mixed at pH 4.85 with a 0.3 mol/l acetate buffer which contains heparin. At the pH of 5.12 established, an immediate precipitation of the LDL, of the subclasses of the LDL, of Lp (a) and of fibrinogen occurs. The suspension is passed through a 0.4 μm polycarbonate filter in order to retain the precipitate. The remaining plasma or serum is then freed of excess heparin with the aid of an ion-exchanger column, and returned to physiological conditions by means of an ultrafiltration with dialysis before it is returned to the patient mixed with the blood cells. During a treatment, as a rule, three liters of plasma are processed. This leads to an elimination of about 60% of the corresponding plasma lipoproteins circulating in the blood. This amount is sufficient in order, for example, to increase 0.5 to 1.5 liters of human plasma to the concentrations in the upper normal or pathological range of lipoproteins.

1.4 Obtainment of LDL and Lp(a) fractions in native form

The cartridge obtained after the H.E.L.P. treatment of a patient, which contains the precipitate of the lipoproteins eliminated from the plasma, is eluted with a suitable buffer. Preferably, the pH of the buffer is between 5 and 9, a pH of 7.5-8 being particularly preferred. The molarity of the buffer is preferably between 0.02 and 0.50 mol/l, particularly preferably 0.1 mol/l. Tris HCl, for example, is suitable as a buffer salt. Furthermore, the buffer preferably contains a lipid-free protein, e.g. delipidated fatty acid-free albumin. The proportion by weight of the protein is preferably in the range from 0.5 to 5% (w/w), particularly preferably 2.5%. It is furthermore preferred that the buffer contains NaCl in a proportion by weight of 0.05 and 5.0% (w/w), particularly preferably 1.0%. For the elution, favorably a buffer volume which is as low as possible of, for example, ≦300 ml per cartridge is used. The elution is preferably carried out under recirculating conditions.

The eluate is treated with EDTA and sodium azide to increase its stability and can then be further sequentially ultracentrifuged or readsorbed, reprecipitated or refiltered in a manner known to the person skilled in the art in order to obtain the desired plasma fractions. These optional purification steps can also be used for the further separation of coprecipitated and/or coeluted plasma proteins and the additional concentration of the fractions.

A lipid-free protein, e.g. delipidated albumin, is then added to the lipoproteins and/or lipoprotein fractions obtained in this manner to increase their stability, its proportion by weight preferentially being between 0.5 and 5% (w/w), particularly preferably approximately 2.5%. The lipoproteins can subsequently be subjected to dialysis, e.g. against a 0.9% NaCl/tris buffer pH 7.4 in the presence of EDTA and sodium azide and/or lyophilized.

### Example 2

### Preparation of Infusion Solutions for Therapeutic Purposes

The components obtained according to the invention such as, for example, Lp(a) or HDL are suitable for preparing infusion solutions for therapeutic purposes, solutions of this type being distinguished by a very high content of the components(s) such as, for example, HDL or Lp(a). For this purpose, the corresponding component such as, for example, HDL or Lp(a) is added in dissolved or lyophilized form to a physiological saline solution or another solution which is suitable and known for infusion purposes to the person skilled in the art. The solutions employed or prepared are sterilized in the manner known to the person skilled in the art, for example by filtration through suitable membranes. As a therapeutic approach, an HDL deficiency or alternatively septic conditions is suitable.

### Example 3

### Preparation of Solutions for the Preparation of Nutrient and/or Incubation Media

The components obtained according to invention—such as, for example, the lipoproteins—are suitable for preparing nutrient and/or incubation solutions for biological purposes such as, for example, the culturing of cells, solutions of this type being distinguished by a very high content of the native components(s)—such as, for example, the lipoproteins or their constituents (cholesterol, triglycerides, phospholipids).

For this purpose, the corresponding component(s)—such as, for example, the lipoproteins—is added in dissolved or lyophilized form to a physiological saline solution or another suitable nutrient and/or incubation solution known to the person skilled in the art.

### Example 4

### Preparation of Standard and Control Samples

The components obtained according to invention, e.g. the lipoprotein fractions LDL or Lp(a) (cf. example 1) are suitable for preparing control or standard materials for diagnostic tests. For this, a synthetically prepared sample matrix, e.g. a physiological saline solution, an albumin solution, a buffer solution, a depleted biological fluid or a natural sample matrix such as, for example, blood, plasma, serum urine or cerebrospinal fluid can be built up with the isolated components.

It was possible, for example, to build up a serum pool with LDL cholesterol up to a concentration of over 1000 mg/l or with Lp(a) up to a concentration of up to over 300 mg/l. For building-up, it was also possible to employ lyophilized products. The standards and controls prepared in this manner which have a high content of LDL cholesterol, and/or Lp(a), exhibit no turbidity at all and are therefore outstandingly suitable for carrying out diagnostic tests. Gel electrophoresis investigations furthermore showed that the added components are present in native form. It was not possible to find any degradation products.

1. A process for the obtainment of biological components, comprising the recovery in biologically native and active form of components which have previously been separated off from a body fluid.

2. The process as claimed in claim 1, characterized in that
the separation comprises a precipitation, an adsorption or/and a filtration.

3. The process as claimed in claim 1 or 2, characterized in that
the body fluid is selected from blood, plasma or serum which can originate from a human or an animal.

4. The process as claimed in one of the preceding claims 1 to 3, characterized in that
a freshly obtained or preserved body fluid is used.

5. The process as claimed in one of claims 1 to 4, characterized in that
the separation is carried out in an extracorporeal system.

6. The process as claimed in one of claims 1 to 5, characterized in that
the biological components comprise the products obtained in an apheresis.

7. The process as claimed in one of claims 1 to 6, characterized in that
the biological components have been separated in the course of a therapy.

8. The process as claimed in one of claims 1 to 7, characterized in that
the biological components are high molecular weight substances and complexes.

9. The process as claimed in one of claims 1 to 8, characterized in that
the biological components are proteins, peptides, lipoproteins, cytokines, growth factors, anti-bodies, enzymes, hormones, lipopolysaccharides and lipoteichoic acids.

10. The process as claimed in claim 9, characterized in that
the biological components comprise plasma lipoproteins—VLDL, LDL, HDL, Lp(a)—or mixtures of these in biologically native form.

11. The process as claimed in claim 9, characterized in that
isoforms of the lipoproteins are isolated.

12. The process as claimed in one of the preceding claims, characterized in that
the recovery comprises a reconstitution of the biological components in a buffer which contains a lipid-free protein.

13. The process as claimed in claim 12, characterized in that
delipidated albumin is used.

14. The process as claimed in one of the preceding claims, furthermore comprising the lyophilization of the biological components.

15. The process as claimed in claim 14, furthermore comprising the reconstitution of the lyophilized components in a suitable medium.

16. The use of the biological components obtained by the process as claimed in one of claims 1 to 15 for the preparation of controls or standards for diagnostic tests.

17. The use as claimed in claim 16 for the preparation of controls or standards for the determination of lipoproteins, cholesterol, triglycerides and phospholipids, and their fatty acid samples.

18. The use as claimed in claim 16 for the preparation of controls or standards for the determination of (apo)lipoproteins, preferably the (apo)lipoproteins A, B, C, E and D and isoforms thereof.

19. The use as claimed in one of claims 16 to 19 for the preparation of controls or standards which contain a component to be detected in the upper normal range or in the pathologically elevated range.

20. The use of the components obtained by the process as claimed in one of claims 1 to 15 for the preparation of nutrient or/and incubation media for cell cultures.

21. The use of the biological components obtained by the process as claimed in one of claims 1 to 15 for use for therapeutic purposes.

22. The use as claimed in claim 21, characterized in that
an infusion solution is prepared.

23. The use as claimed in claim 22, characterized in that
the infusion solution contains lipoproteins, in particular HDL or/and Lp(a) for the prevention or/and treatment of an infection or septicemia or of an HDL deficiency.
